(19) United States
(12) Patent Application Publication
(10) Pub. No.: US 2017/0302387 A1
(43) Pub. Date: Oct. 19, 2017

(54) INTERCONNECT FOR MICRO FORM-FACTOR PHOTONIC

(71) Applicant: Lattice Semiconductor Corporation, Portland, OR (US)

(72) Inventor: Kihong Kim, San Jose, CA (US)

(21) Appl. No.: 15/488,291

(22) Filed: Apr. 14, 2017

Related U.S. Application Data
(60) Provisional application No. 62/323,140, filed on Apr. 15, 2016.

(51) Int. Cl. H04B 10/80; G02B 27/09; G02B 6/42; G02B 6/38; H04B 10/25; G02B 6/32

(52) U.S. Cl. CPC H04B 10/803; H04B 10/2504; G02B 27/0927; G02B 6/32; G02B 6/4206; G02B 6/3809; G02B 6/4292

(57) ABSTRACT

A ferrule-less optical interconnect includes electrical communications assembly having a receptacle disposed in a housing, the receptacle adapted to mate with an electrical connector to produce a free space gap, and active optical communications components disposed in the housing and adapted to process a free space optical beam traveling along a first optical beam path through the free space gap. The free space optical beam has a substantially parallel shape and Gaussian power density distribution. Active optical components may include a light source and a collimator adapted to produce the free space optical beam. Active optical components may include a condenser adapted to receive the free space optical beam and produce a focused optical beam signal for reception by a sensor. A hole is disposed in the housing along the first optical beam path providing free space passageway between the active optical communications components and the free space gap.

### CROSS-REFERENCE TO RELATED APPLICATION

This application claims the benefit of U.S. Provisional Patent Application No. 62/323,140, filed Apr. 15, 2016, which is incorporated by reference herein in its entirety.

### TECHNICAL FIELD

This disclosure relates generally to optical communications, and more specifically to optical interconnects for small and micro form factor devices.

### BACKGROUND

Small and micro form factor devices, such as mobile phones and tablets, offer limited modes of communication with other devices. It is common for such devices to have a single communications port configured to receive an electrical connector, as specified by one or more electronic communications standards. For example, many consumer electronics devices are limited to communicatively coupling with other devices, such as a personal computer or an audio/video system, through the available communications port using one or more communications standard, such as USB or HDMI. Adding communications ports for other standards or modes of communication may not be practical due to additional cost and the desire to maintain a small device size. As a result, other communications methods, such as optical communications, are not readily available in many small and micro form factor devices. There is therefore a need for improved systems and methods for facilitating optical communications with small and micro form factor devices.

### BRIEF DESCRIPTION OF THE DRAWINGS

FIG. 1 is a block diagram of an exemplary optical interconnection system in accordance with an embodiment of the present disclosure.

FIG. 2 is a block diagram illustrating optical coupling loss through misalignment of optical axes in accordance with an embodiment of the present disclosure.

FIG. 3A is an exemplary plot of a flat top beam profile in accordance with an embodiment of the present disclosure.

FIG. 3B is an exemplary plot of a Gaussian beam profile in accordance with an embodiment of the present disclosure.

FIG. 3C is a plot of a cross section of an exemplary beam profile mask in accordance with an embodiment of the present disclosure.

FIGS. 3D and 3E are plots of exemplary passing and failing beam profiles, respectively, in accordance with an embodiment of the present disclosure.

FIGS. 4A and 4B are block diagrams illustrating exemplary non-zero gap coupling in accordance with an embodiment of the present disclosure.

FIG. 5 is an exemplary plot of a transmitting aperture diameter vs. collimated Gaussian beam range in accordance with an embodiment of the present disclosure.

FIG. 6A illustrates an exemplary eye mask of an electrical specification in accordance with an embodiment of the present disclosure.

FIG. 6B is a block diagram illustrating an exemplary electrical pin interface in accordance with an embodiment of the present disclosure.

FIG. 7 is an exemplary state diagram for device discovery in accordance with an embodiment of the present disclosure.

FIGS. 8A and 8B are block diagrams illustrating exemplary misalignment tolerances in accordance with an embodiment of the present disclosure.

FIGS. 9A, 9B and 9C are block diagrams of an exemplary communications port and corresponding connector in accordance with an embodiment of the present disclosure.

FIGS. 10A, 10B and 10C are block diagram of an exemplary communications port and corresponding connector in accordance with an embodiment of the present disclosure.

FIG. 11 is a block diagram of an exemplary optical passive component to optical passive component coupling in accordance with an embodiment of the present disclosure.

Aspects of the disclosure and their advantages can be better understood with reference to the detailed description that follows. It should be appreciated that like reference numerals are used to identify like elements illustrated in one or more of the figures, wherein showings therein are for purposes of illustrating embodiments of the present disclosure and not for purposes of limiting the same. The components in the drawings are not necessarily to scale, emphasis instead being placed upon clearly illustrating the principles of the present disclosure.

### DETAILED DESCRIPTION

In accordance with various embodiments of the present disclosure, systems and methods for interconnecting small and micro form factor devices through optical connections are provided. In one embodiment, a ferrule-less, non-contact, optical interconnect system and method is provided. The ferrule-less optical interconnect includes optical active components, including an optical beam source, such as a laser diode, for generating an optical beam meeting a minimum Gaussian beam profile, and a collimator for shaping a free space beam. The optical active components may also include a sink, such as a photodiode, and a condenser for focusing a free space beam. An optical connector includes optical passive components to receive the free space beam and shape the beam for propagation through an optical cable.

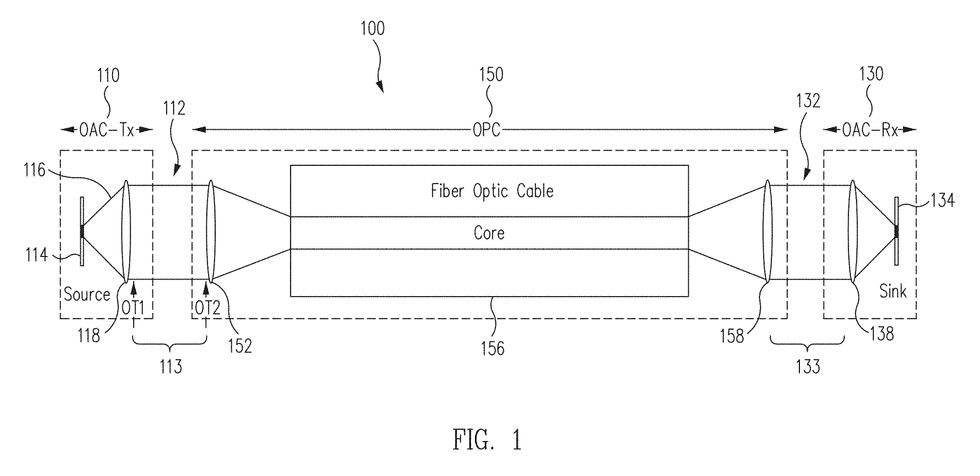

Referring to FIG. 1, an embodiment of an optical interconnect will be described. An optical interconnect system 100 includes an optical active components transmitter (OAC-Tx) 110, optical active component receiver (OAC-Rx) 130 and optical passive components (OPC) 150. In operation, the OAC-Tx 110 generates a free space beam 112 that travels through the gap 113 to a first end of the OPC 150. The OAC-Rx 130 generally uses a similar configuration for receiving a free space beam 132 formed by the OPC 150.

In one embodiment, the OAC-Tx 110 is disposed in a first host device, such as a mobile phone or tablet, and includes an optical source 114 that receives electrical signals from the host device and converts the electrical signals into an optical signal. In one embodiment, the optical source 114 includes a laser diode, such as a vertical cavity surface emitting diode (VCSEL), arranged to generate diverging optical beam 116. The OAC-Tx 110 further includes collimating lens 118 (collimator), which shapes the beam 116 to form collimated free space beam 112.

The OPC 150 includes a first lens 152, which receives the collimated free space beam 112 and focuses the beam for transmission through the core of fiber optic cable 156, and a second lens 158 for shaping the beam to form collimated free space beam 132 which travels across gap 133.

In one embodiment, the OAC-Rx 130 is disposed in a second host device, such as an A/V system, and includes an optical sink 134 that converts the received optical signal to electrical signals for processing by the second host device. In one embodiment, the OAC-Rx 130 includes a condenser lens 138 that focuses the collimated free space beam towards a photodiode (PD), which is arranged to sense the optical signal.

In an alternate embodiment, the OPC may include a conventional optical connector on one end, such as ferrule, for optically coupling with conventional optical devices. Further, each of the first host device and second host device may include one or more OAC-Tx and OAC-Rx components for bi-directional or multichannel communications. In various embodiments, the fiber optic cable may include a plurality of optical fibers and/or may be joined with electrical wires providing electronic communications in a hybrid arrangement. Although a single fiber optic cable is illustrated, the optical path between the OAC-Tx 110 and OAC-Rx 130 may include a plurality of OPCs coupled together.

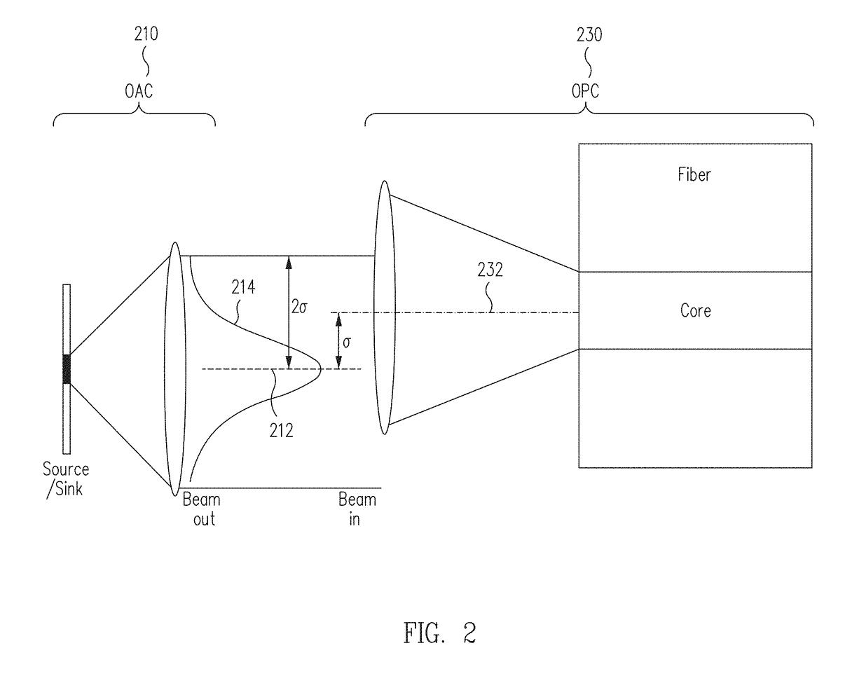

Referring to FIG. 2, alignment of the OAC and OPC will now be discussed with reference to the optical axis 212 of the OAC 210 and the optical axis 232 of the OPC 230. In various applications, coupling loss as illustrated might occur due to manufacturing or in field use (e.g., at a consumer's home). Misalignment of the optical axis 212 with the optical axis 232 can result in a loss of light energy and a disruption of communications. In the present embodiment, misalignment errors are attenuated, in part, by the selection and use of an optical beam profile suitable for use in the embodiment of FIGS. 1 and 2.

The exemplary optical beam profile disclosed herein will be understood with reference to the ray transfer matrix and use of the paraxial approximation of ray optics, including the paraxial wave equation with complex beam parameter. As illustrated, the collimated output beam 214 has a Gaussian power distribution profile, which minimizes coupling loss due to misalignment where the misalignment is by small amount relative to the overall beam diameter. In such cases, the misalignment affects mainly the tail parts of Gaussian distribution. In the illustrated embodiment, the loss is approximately 20% which is about 1 dB loss for 1 a misalignment.

Using a Gaussian beam profile has additional advantages including the availability of lasers with Gaussian beam profiles and the Gaussian waveform being a fundamental eigensolution for the paraxial wave equation used in some transceiver optical systems. However, many lasers produce beams that are non-ideal Gaussian. In one embodiment, a minimum Gaussian profile (MGP) is defined such that a non-Gaussian beam that satisfies the MGP can have reliable coupling power for an optical link as described herein.

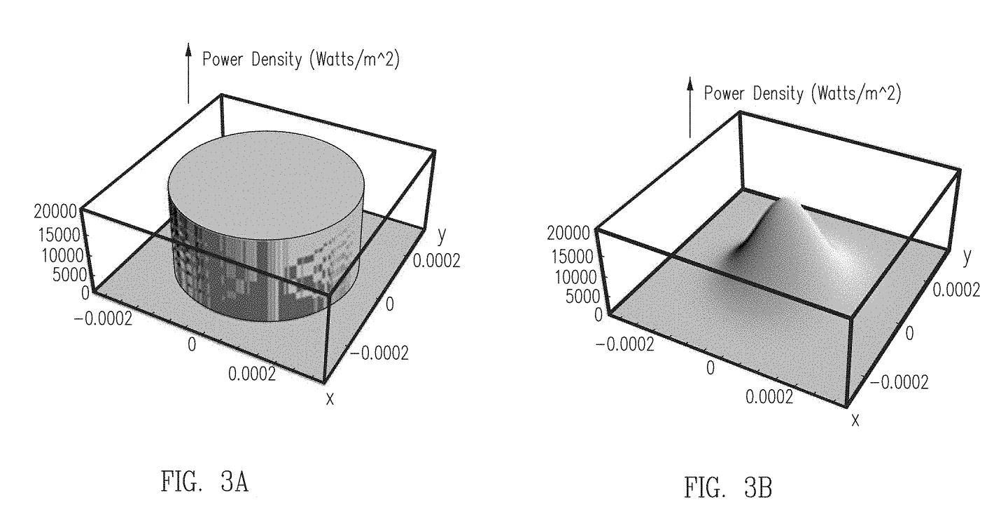

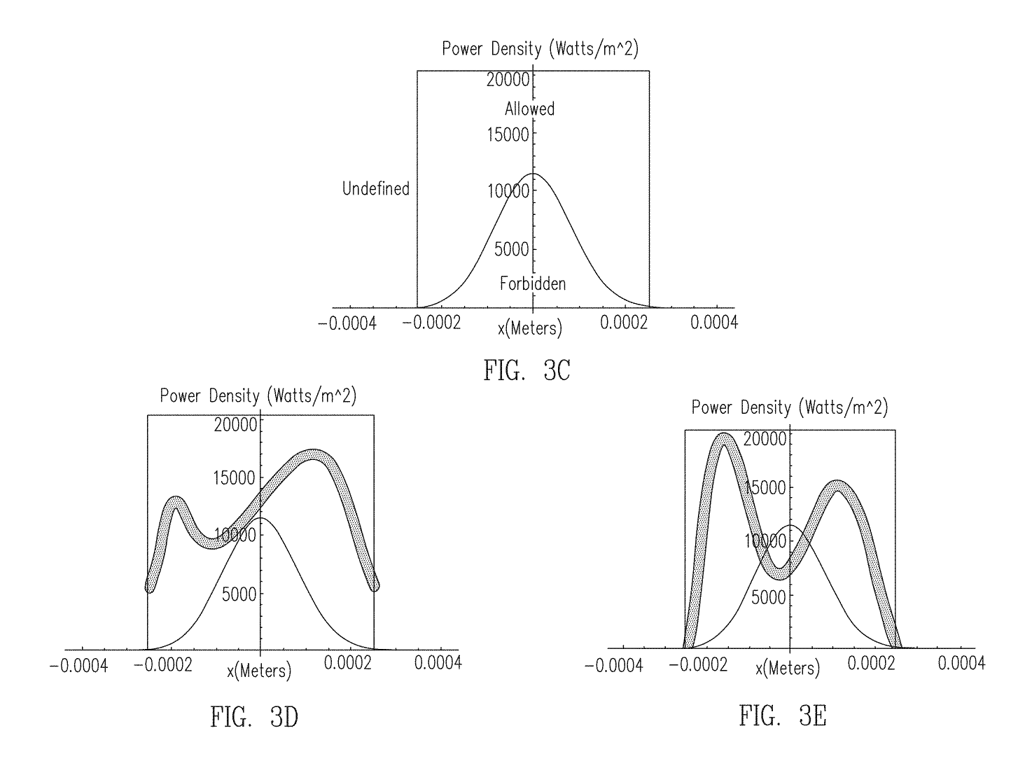

A beam profile mask is defined and explained below which includes details of Gaussian beam parameters in accordance with embodiments of the present disclosure. In one embodiment, the beam profile mask is comprised of a Flat Top Profile (FTP) as an upper bound and Minimum Gaussian Profile (MGP) for the lower bound. The Flat Top Profile is given in the following equation and is illustrated in the exemplary 3-dimensional plot of FIG. 3A:

FTP(x,y)=2.03718×10⁴×U(2.5×10⁻⁴−\sqrt{x²+y²}) (Watts/m2)
where U(t) step function defined by,

$$U ( t ) = \{ \begin{matrix}1 if t > 0 \\ 0 if t < 0\end{matrix} \qquad ( 1 )$$

The Minimum Gaussian Profile is given by the following equation and is illustrated in the exemplary 3-dimensional plot of FIG. 3B:

MGP(x,y)=1.14592×10⁴×e^{{-7.2×10}^{⁷}^{×(x}^{²}^{+y}^{²}^{)}} (Watts/m2) (2)

FIG. 3C shows a cross section of the mask at y=0. Exemplary profiles that have passed and failed are shown in FIGS. 3D and 3E, respectively.

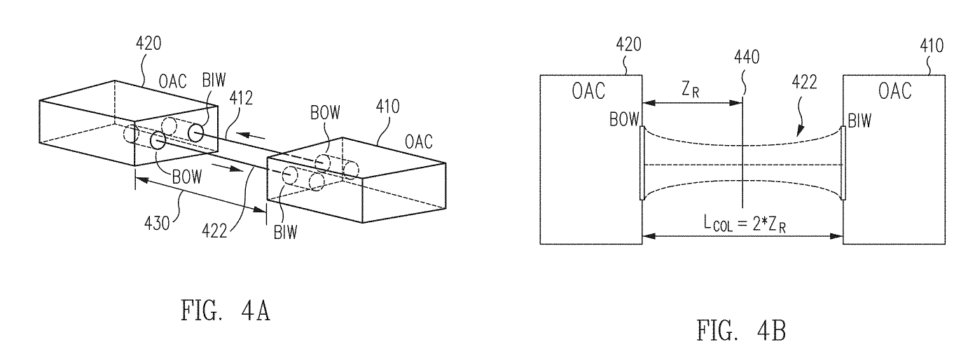

In various embodiments, non-zero gap (NZG) optical coupling between the optical active components and optical passive components is used. Non-zero gap (NZG) optical coupling will be described in further detail with reference to FIGS. 4A and 4B. By using NZG, burdens on consumer electronics manufactures to add optical receptacles and invest in precision equipment for proper alignment of conventional optical interconnects is alleviated.

FIG. 4A is an embodiment of a direct, free space, bi-directional communication channel in accordance with the present disclosure. As illustrated, each channel, 412 and 422, is implemented using a free space Gaussian beam (ideal or non-ideal Gaussian beam as described herein) from transmitter to receiver between two chips, 410 and 420, respectively. In this embodiment, both chips are sufficient aligned physically with each other and the beams do not substantially diverge or converge. The non-zero gap 430 of the present embodiment allows spacing between the beam output window (BOW) and the beam input window (BIW) when the light signal is traveling off-chip (i.e. off-OAC).

In practice, a spatially coherent Gaussian beam diverges, and ideal collimation is not possible. Referring to FIG. 4B, in one embodiment the beam is substantially collimated to provide minimal focusing such that the beam waist 440 is located in the middle of L_{col}, and such that beam diameter at BOW and BIW are both increased from the diameter of the beam waist. In one embodiment, the beam diameter at BOW and BIW are both increased by the square root of the beam waist radius. In the illustrated embodiment the collimation length, L_{col}, is related to the Rayleigh range—the distance from the waist 440 of the beam to the point at which the area of the cross section of the beam is doubled. L_{col} may be defined for any OAC such that the beam waist is located in the middle of L_{col} such that beam diameter at BOW and BIW are both greater than the beam waist diameter and increasing from the beam waist. Here, the Gaussian beam output from the transmitter of OAC 420 is collimated up to minimum 100 mm such that L_{col}≧100 mm.

In one embodiment, optical beam characteristics are based on paraxial approximation where the ray angle (θ) from an axial (z-axis) direction holds the following approximation, tan θ≅θ. Beam parameters and related definitions can be found in industry standard, ISO11146-2, which describes laser beam characteristics using second order moments of the Wigner distribution, and is incorporated by reference herein in its entirety. Theoretically, this can be used on any optical beam, regardless of where it is Gaussian or non-Gaussian, fully coherence or partially coherence, single mode or multiple transverse mode.

Exemplary beam parameters for the illustrated embodiment are set forth below:

i. D_{beam} (Beam waist: D4σ)=4σ, where σ is defined at z₀ by

$$σ = \sqrt{\frac{{\int }_{- ∞}^{∞} {\int }_{- ∞}^{∞} {( x - {x}_{0} )}^{2} I ( x , y ) dxdy }{{\int }_{- ∞}^{∞} {\int }_{- ∞}^{∞} I ( x , y ) dxdy}} \qquad ( A1 )$$

and I(x,y) is optical power density at beam waist location, z₀, of beam with ε (Beam Ellipticity≡d_{σ(short}_{_}ₐₓᵢₛ₎/d_{σ(long}_{_}ₐₓᵢₛ₎ being less than 0.87 (see ANSI 11146-1)

ii. θ_{f} (Divergence Full Angle)=2×θₕ, where θₕ is half angle of beam divergence (subtending angle from origin to 2σ of far field Gaussian profile)

iii. BPP (Beam parameter product)=w₀×θₕ

iv. M² (Beam propagation ratio)=π×BPP/λ (A2)

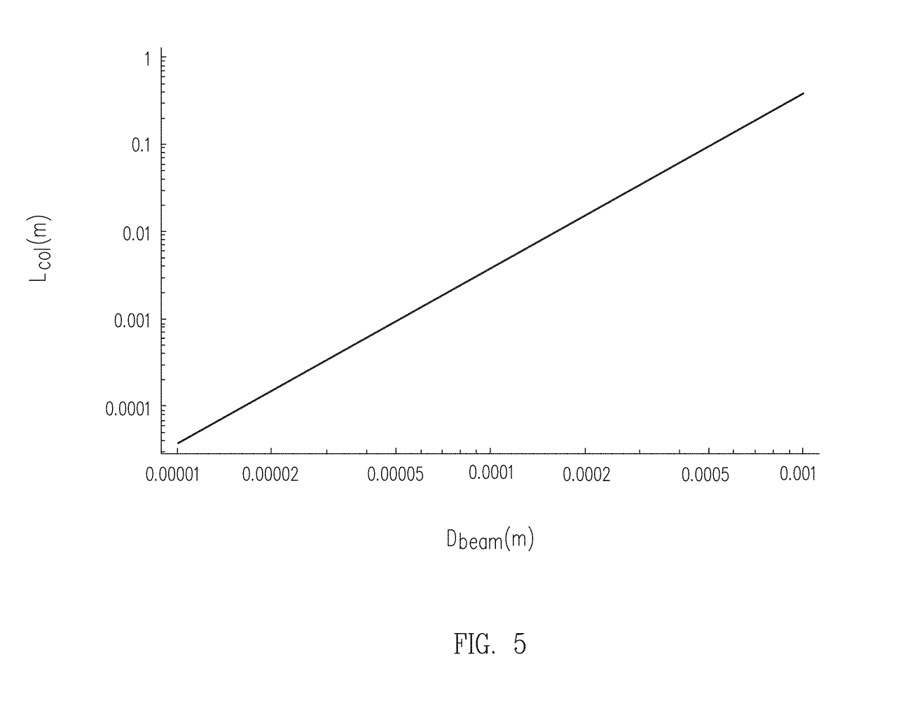

The optical interface in the connector is specified by the Beam Parameter Product (BPP) defined by

$$BPP ≡ \frac{{D}_{beam @ OT 1} \times {θ}_{max}}{4}$$

where D_{beam@OT1} is the beam diameter of 4σ, θₘₐₓ is beam divergence at BOW (beam output window) of the optical transmitter assuming the beam is stigmatic, and OT1 is a first optical test point (see, e.g., FIG. 1). For example, diffraction limited Beam Parameter Product, BPPg, can be achieved for ideal Gaussian Beam for λ=850 nm which is approximately BPPg=0.271 mm·mrad. FIG. 5 shows an exemplary plot for the transmitting aperture diameter (D_{beam}) vs. the collimated Gaussian beam range (L_{col}) for a Gaussian beam of the same wavelength.

The illustrated embodiment allows beam distortions from OT1 signal due to ULPI (unintentional light path impairment) such as misalignment, reflection, bending, thermal distortion of optical media including air, dust etc. Thus, beam parameters in the illustrated system at optical test point 2 (OT2, the optical location at BIW) allows the increase of BPP (as also described below in terms of M² value). The tables, below, summarize an exemplary specification for related parameters at OT1 (BOW) and OT2 (BIW):

Optical beam specification at OT1

| | Min. | Typ. | Max. |
|---|---|---|---|
| D_{beam@oT1}(um) | 450 | 500 | 550 |
| [symbol] ₘₐₓ(mRad/°) | | 10/0.57 | 22/1.26 |
| BPP (mm · mrad) | BPPg@850 nm | 1.25 | 3.0 |

Optical beam specification at OT2

| | Min. | Typ. | Max. |
|---|---|---|---|
| D_{beam@oT2}(um) | 450 | 500 | 550 |
| [symbol] ₘₐₓ(mRad/°) | | 30/0.57 | 66/1.26 |
| BPP (mm · mrad) | BPPg@850 nm | 3.75 | 9.1 |

The present embodiment allows maximum M² increase (MSI) through the light path through which the signal beam travels from OT1 to OT2 via any OPC (optical passive component) or ULPI (unintentional light path impairments). Thus, the light path in the present embodiment meets the following MSI specification: minimum MSI=1.0 (0 dB); maximum MSI=3.0 (4.7 dB).

Exemplary total signal power for OT1 and OT2 in the present embodiment are set forth in the following table, in which the total power of a collimated beam is defined within the circle having the diameter of D_{beam@OT1} and D_{beam@OT2}, respectively:

| | Min. | Typ. | Max. |
|---|---|---|---|
| OT1 (ouput) | −3 dBm | −2 dBm | 1 dBm |
| OT2 (input) | −9 dBm | −3 dBm | 0 dBm |

It will be appreciated by those having skill in the art that this optical signal specification provides advantages in link performance such as BER or analog noise when collimating and focusing correctly.

One goal of the present embodiment is to make use of commonly accessible electrical interfaces that are commonly available for use on small devices and accessible by existing electrical Serializer/Deserializer (SERDES) components used in high speed communications, such as using existing USB and/or HDMI interface components through minimal passive (or non-) modification by external circuit introduction.

Exemplary electrical specifications for the illustrated embodiment are set forth below.

| | |
|---|---|
| Power ground rail | 1.8 V TX/RX interface |
| Bandwidth | f_{MFP}(bps) capabilities = 10 G; 12.5 G; |
| | 25 G |
| T_{bit} | T_{bit} ≡ 1/f_{MFP}: 100 ps; 80 ps; 40 ps |
| TX differential input at T1: | 600 mVpp/1000 mVpp |
| min/max | |
| Rx differential output at | 300 mVpp/500 mVpp |
| T2: min/max | |
| Eye-width (Jitter and | Tx input jitter allowed: Jt >0.4 UI |
| skew) | Rx output jitter max: Jt <0.5 UI |
| | Intra pair skew generation at Rx: <0.05 |
| | UI |

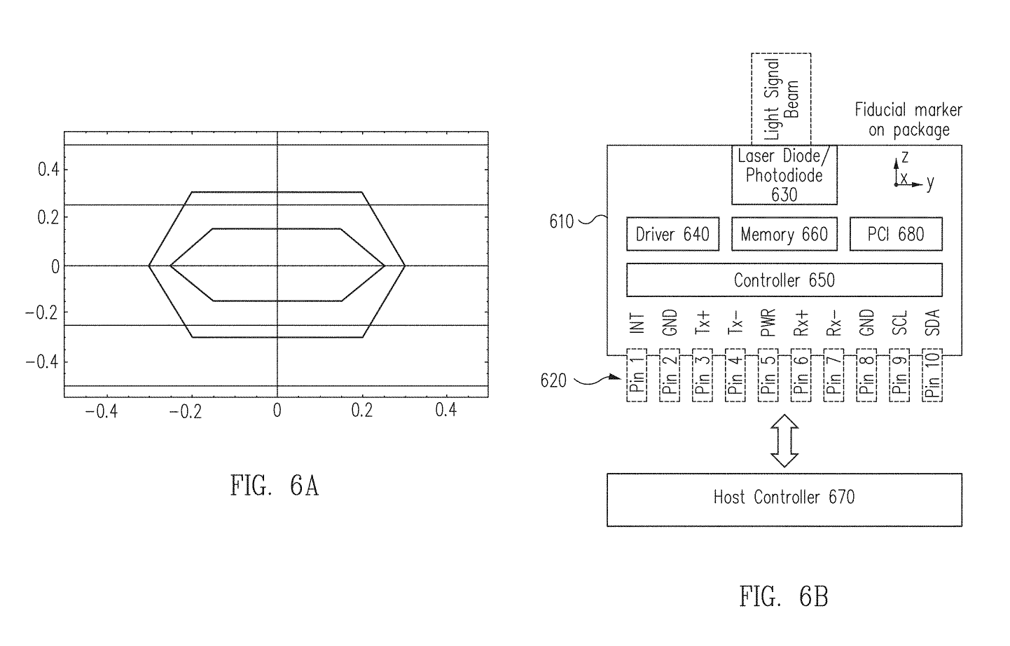

These specifications may not be ideal to electrically drive (or be driven by) a cable connector in many applications, but are sufficient to drive board trace of minimal 10 cm in tested embodiments. FIG. 6A illustrates an eye mask of the exemplary electrical specification.

FIG. 6B illustrates an exemplary semiconductor package 610 and electrical I/O pins 620. In one embodiment, I²C is used as a control interface to control local micro form factor photonics. The mechanical assembly may include a fiducial marker for reference in aligning the beam path. Depending on the implementation, the package 610 may function as a transmitter, receiver or transceiver and include one or more laser diodes/photo diodes 630, a driver 640, controller 650, memory 660 (which may be implemented as volatile or non-volatile memory, including a non-transitory computer readable medium) and other circuitry and logic, as appropriate. The device is generally controlled by an I²C interface for set-up, loss of signal (LOS), hot-plug detect, device discovery, contention resolution and other operational features. These and other operations may be implemented through a combination of dedicated circuitry and components and program logic stored in memory 660 for implementation by controller 650. In addition to two I²C pins, INT pin is provided to interrupt any process when it requires by local controller 650 or a remote processor, such as host controller 670.

In one embodiment, the controller 650 monitors loss of signal and whether the optical receiver receives proper level of optical power to avoid performance targets of bit error rate or analog signal to noise ratio. The loss of signal may also be tracked for safety to avoid the optical beam straying around non-defined optical path such that human eyes can be exposed or other safety concerns avoided. Optical power level is recommended to be set at Pₗₒₛ (of −12 dBm for example) at Rx through I²C.

A hot-plug of an optical link may be detected optically by monitoring optical power as long as both Tx and Rx are electrically powered through beacon light coming out from Tx and sensed at Rx with optical power of P_{bcn}=Pₗₒₛ−3 (informative). Therefore, normal operation of an optical link may discriminate whether the optical input is a relative drop due to loss of service or absolute changes of all optical input power including signal power level compared to the setting values described above.

In one embodiment, device discovery is achieved through a photon-copper interworking (PCI) block 680, which emulates auxiliary interface functions such as device discovery or other upper layer protocols. There are certain physical layer issues to translate the analog electrical signal into optical domain. The present embodiment defines a new functional block in-between electrical-to-optical interface to fulfill the link set-up process. The PCI block 680 is implemented to translate such functions in which case the information of electrical connect (or disconnect) is transferred to the optical domain, and vice versa. Although in the optical domain there are many possible ways to transmit and receive the bi-directional information on one optical fiber, the media should be transferred in-between optical and electrical. Thus a simplified processing controller for such purpose is recommended to implement such PCI with two wire communications in between.

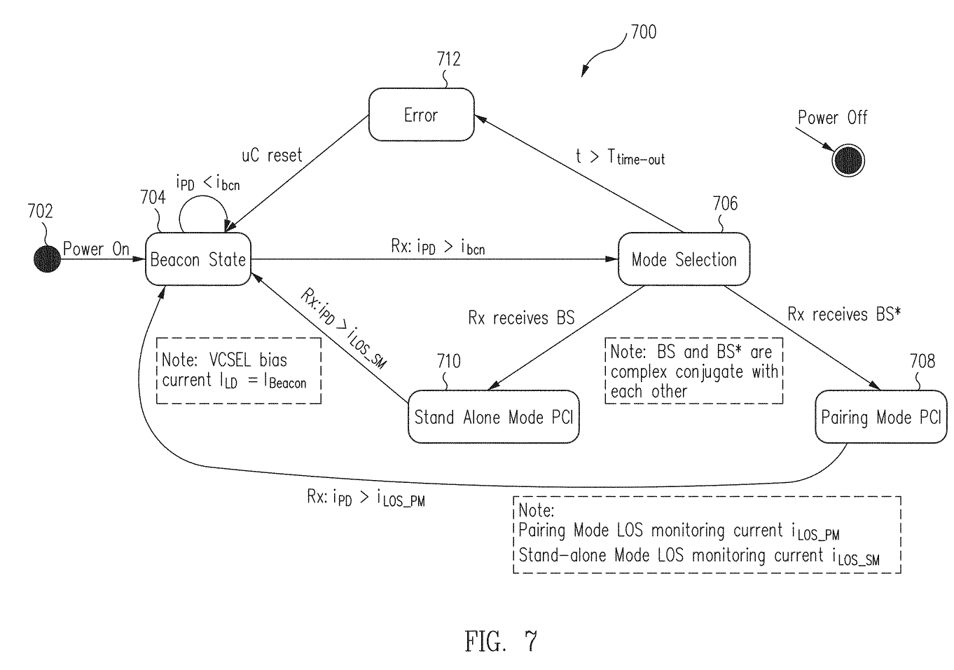

An embodiment of a beacon to PCI state diagram 700 is illustrated in FIG. 7. At 702, the optical components are powered on and the beacon state is detected in block 704. Control remains at block 704 while the current measured at photodiode, i_{PD}, is less than a beacon current threshold, i_{bcn}. If the device receives an optical signal such that i_{PD}>i_{bcn} then control is passed to the mode selection block 706. In standalone mode PCI 710, a loss of service process monitors current at the photodiode and compares the measured current to a standalone mode LOS threshold, i_{LOS}_{_}_{SM}. Control passes to beacon state 704 when i_{PD}>i_{LOS}_{_}_{SM}. In the pairing mode PCI block 708, a loss of service process monitors current at the photodiode and compares the measured current to a pairing mode LOS threshold, i_{LOS-PM}. Control passes back to beacon state 704 when i_{PD}>i_{LOS}_{_}_{PM}. If mode selection 706 times out, control passes to error block 712 which sends resets signal and control passes back to beacon state 704.

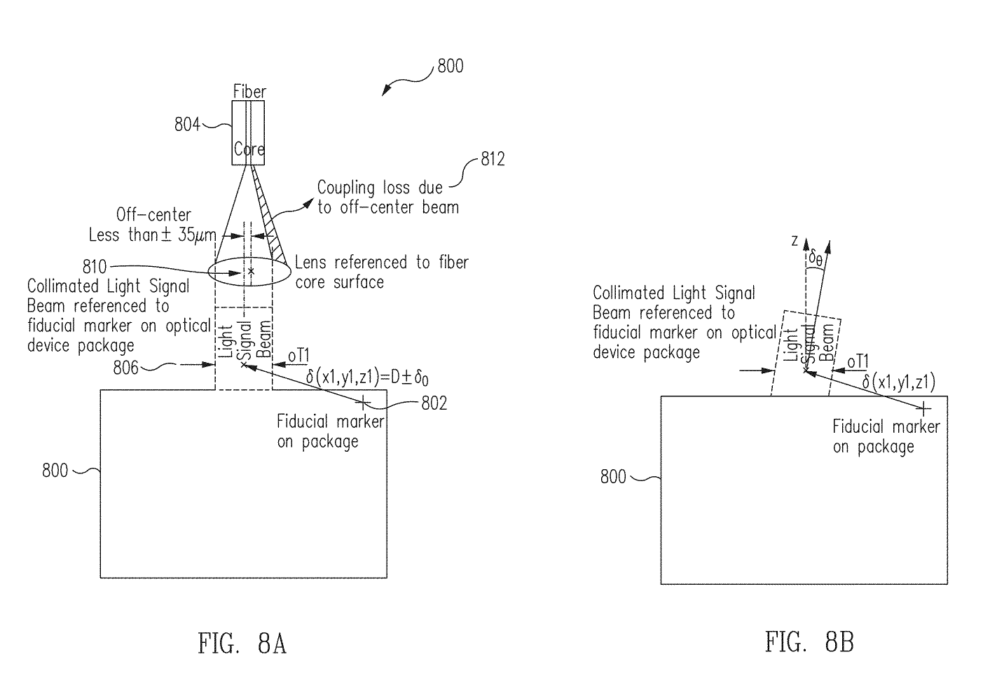

Referring to FIGS. 8A and 8B, misalignment errors will be discussed in further detail. FIG. 8A illustrates an exemplary optical device package 800 with a reference point 802 for aligning the light signal beam with the core of an optical fiber 804. In one embodiment, the maximum displacement target between the core and the optical device package is δ₀=35 μm for reliable communications. As illustrated, a misalignment 810 by 35 μm or less would yield coupling loss 812 that still allows for reliable communications performance in accordance with the specifications herein. FIG. 8B illustrates misalignment due to angle of displacement. In one embodiment, the maximum angular displacement with reference to the desired beam path is δ₀=0.35 mrad.

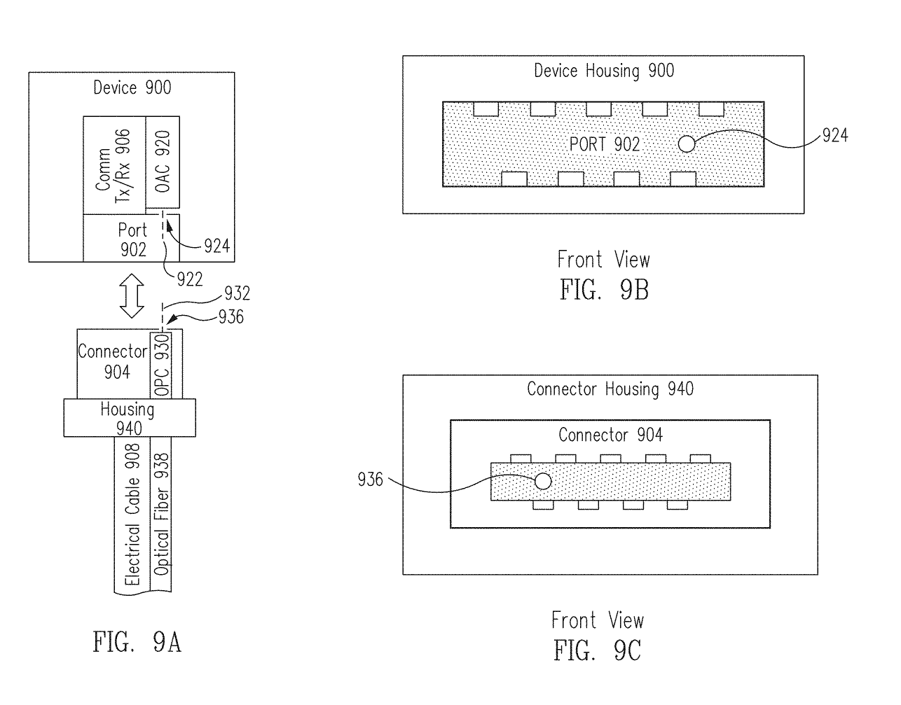

Referring to FIGS. 9A, 9B and 9C, an interconnect system implementing the present disclosure will now be described. A device 900, such as a mobile telephone, includes a communications port 902 for receiving a corresponding connector 904. The port 902 is controlled by communications transceiver (Tx/Rx) components 906, which facilitates communications between the device 900 and another device (not shown) through the communications cable 908. In various embodiments, Tx/Rx 906, port 902, connector 904 and cable 908 are configured to provide communications in accordance with a digital or analog electrical communications standard, such as HDMI or USB.

For many devices, it is desirable to maintain a small form factor and adding additional ports is not a desirable option. In the illustrated embodiment, optical active components (OAC) 920 are provided, including an optical source that generates a beam along beam path 924. In other embodiment, the OAC 920 may include an optical sink that receive a beam along beam path 924. To facilitate the optical communications, the port 902 includes a hole 924 sufficient to allow the beam to travel from the OAC 920, through the hole and into the port 902 along beam path 922. The connector 904 includes corresponding optical passive components (OPC) 930 arranged such that optical path 932 is aligned with optical path 922 when the connector 904 is inserted and communicably coupled with the port 902 for electrical communications.

Referring to FIGS. 9B and 9C, the holes 924 and 936 may be positioned at an available location in the port 902 and on connector 904, respectively. The positions of the holes will vary depending on the arrangement of connector and availability of free space for the optical beam path. The alignment of the connector 904 in port 902 allows the holes 924 and 936 to substantially align for optical communications allowing for non-zero gap optical coupling. The OAC 920 can be positioned within the circuitry of the device 900 and the OPC 930 can be positioned within the connector 904 and/or connector housing 940 and is coupled to an optical fiber 938, which is combined with electrical cable 908 to form a hybrid electrical/optical cable and connector.

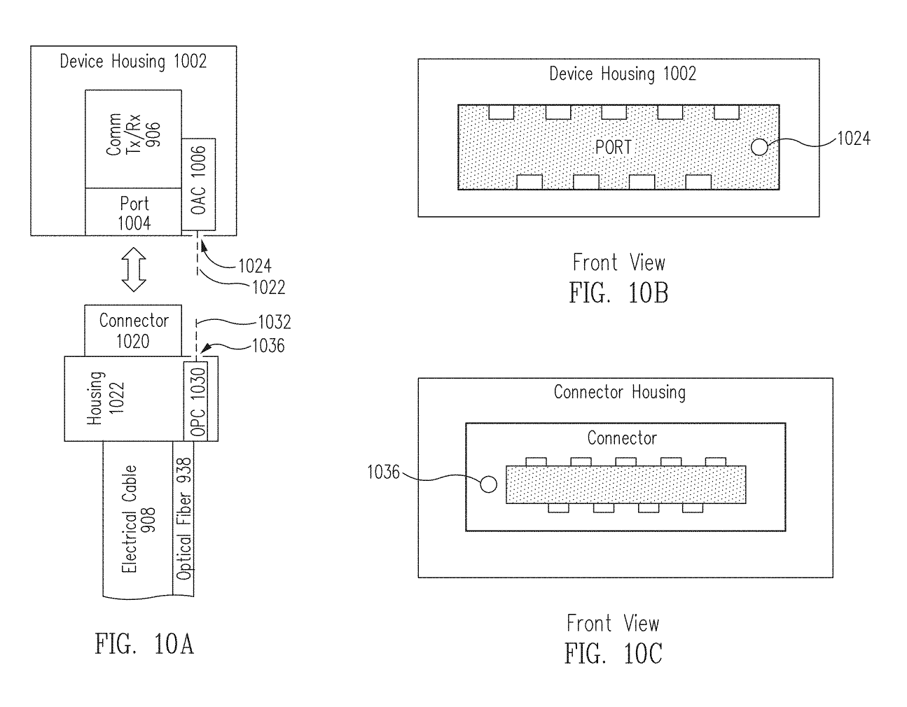

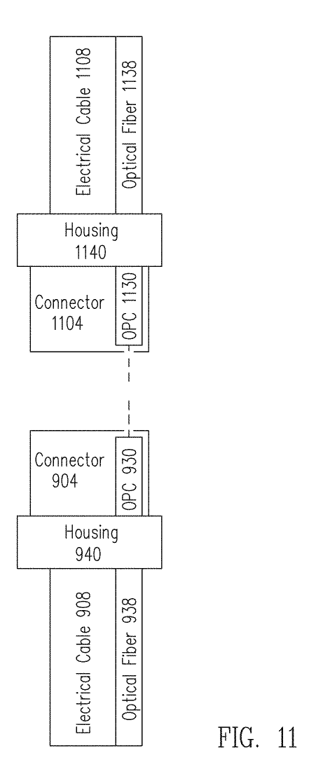

Referring to FIG. 10, an exemplary embodiment of OPC to OPC coupling will now be described. In various embodiments, the OPC 930 may be optically coupled to optical passive components, such as optical passive components 1130. In the illustrated embodiment, the optical passive components 1130 are housed in a hybrid electrical/optical cable and connector including an electrical connector 1104, adapted to receive connector 904 to form an electrical coupling, an electrical cable 1108, a housing 1140 and optical fiber 1138. This arrangement can be used, for example, to connect two or more optical cables in series.

Some interconnect technologies don't provide sufficient open space in the port allowing for optical communications. In one embodiment, the electrical components may be removed from the connector to open up free space in a dedicated optical interconnect cable. In another embodiment, the beam path may be moved to the housing adjacent to the port. Referring to FIGS. 10A, 10B and 100, a hole 1024 is provided in device housing 1002, adjacent to the port 1004. OAC 1006 is aligned adjacent to the hole 1024 allowing the beam to travel along free space beam path 1022. When the connector 1020 is inserted into the port 1004, the connector housing 1022 is positing against or adjacent to the device housing 1002. The connector housing 1022 includes OPC 1030 for transmitting or receiving an optical beam through a hole 1036 in the connector housing 1022, along a beam path 1132, which is substantially aligned with optical path 1022 for optical communications.

The foregoing disclosure is not intended to limit the present invention to the precise forms or particular fields of use disclosed. As such, it is contemplated that various alternate embodiments and/or modifications to the present disclosure, whether explicitly described or implied herein, are possible in light of the disclosure. For example, embodiments with one or two optical connections are described, but a person skilled in the art will understand that the present disclosure may cover any number of optical connections that are physically supportable by the host device. Having thus described embodiments of the present disclosure, persons of ordinary skill in the art will recognize advantages over conventional approaches and that changes may be made in form and detail without departing from the scope of the present disclosure. Thus, the present disclosure is limited only by the claims.

What is claimed is:

1. An optical interconnect comprising:
a communications assembly including a receptacle disposed in a housing, the receptacle adapted to mate with a corresponding connector to produce a free space gap; and
active optical communications components disposed in the housing and adapted to process a free space optical beam traveling along a first optical beam path through the free space gap;
wherein the free space optical beam has a substantially parallel shape and a substantially Gaussian power density distribution.

2. The optical interconnect of claim 1, wherein the free space optical beam has a waist approximately halfway across the length of the free space gap.

3. The optical interconnect of claim 1, wherein the free space optical beam has a beam parameter product (BPP) based on a beam diameter and beam divergence at a beam output window for the free space optical beam along the first optical beam path.

4. The optical interconnect of claim 1, wherein when a mating connection is established between the connector and the receptacle, the first free space beam path is substantially aligned with a corresponding second free space beam path of the connector allowing for optical coupling between the device and connector.

5. The optical interconnect of claim 4, wherein the first optical beam path and second optical beam path are aligned within a misalignment tolerance of two standard deviations, allowing the peak of the Gaussian power density distribution to pass between the first optical beam path and second optical beam path, with coupling loss at the tail end of the Gaussian power density distribution.

6. The optical interconnect of claim 1, wherein the active optical components include a light source adapted to generate an optical beam signal having the Gaussian power density distribution, and a collimator disposed on the first optical beam path and adapted to shape the optical beam signal to produce the free space optical beam traveling across the first optical beam path.

7. The optical interconnect of claim 6, wherein the light source is adapted to produce the optical beam fitting a beam profile mask comprised of a flat top profile at an upper bound and a minimum Gaussian profile at a lower bound.

8. The optical interconnect of claim 1, wherein the active optical components include a condenser disposed on the first optical beam path, the condenser adapted to receive the free space optical beam and produce a focused optical beam signal, and a sensor adapted to receive the focused optical beam signal and generate corresponding electrical signals.

9. The optical interconnect of claim 1, wherein the communications assembly is an electrical communications assembly comprising a first plurality of electrical contacts, and
wherein the connector includes a corresponding second plurality of electrical contacts arranged to adaptively couple with the first plurality of electrical contacts when the connector is mated with the receptacle.

10. The optical interconnect of claim 1, further comprising a hole disposed in the housing along the first optical beam path, the hole providing a free space passageway between the active optical communications components and the free space gap.

11. The optical interconnect of claim 9, wherein the hole is formed in the housing adjacent to the receptacle.

12. The optical interconnect of claim 1, wherein the connector comprises passive optical communications components adapted to process the free space optical beam along a second optical beam path, and
wherein the receptacle is adapted to substantially align the first optical beam path and second optical beam path when mated with the connector.

13. The optical interconnect of claim 12, wherein the connector further comprises a hole disposed along the second optical beam path and providing a passageway between the passive optical components and the free space gap when mated with the receptacle.

14. The optical interconnect of claim 12, wherein the passive optical components includes a lens arrange to receive an optical beam through the second hole in the connector housing along a second free space beam path.

15. The optical interconnect of claim 13, further comprising a fiber optic cable having a core for transmitting optical beam signals,
wherein the lens is a condenser lens adapted to receive the collimated free space beam and generate a converging beam for transmission across the fiber optic core.

16. The optical interconnect of claim 1, further comprising optical monitoring circuitry for hot plug detection of an optical beam in the free space gap.

17. An optical interconnect method for a micro form factor device having a housing containing an electrical communications assembly comprising:
identifying a free space gap between the housing and a connector mated with the electrical communications assembly;
disposing active optical communications components in the housing adjacent to the free space gap, active optical communication components adapted to process a free space optical beam travelling along a first optical beam path, the free space optical beam having a substantially parallel shape and a substantially Gaussian power density distribution; and
forming a hole in the housing, the hole providing a free space passageway between the active optical communications components and the free space gap along a first optical beam path;

18. The method of claim 17, further comprising:
disposing passive optical communication components in the connector, the passive optical communications components adapted to process the free space optical beam along a second optical beam path, and
mating the connector with the electrical communications assembly to substantially align the first optical beam path and second optical beam path, allowing for optical coupling across the free space gap.

19. The method of claim 18, wherein the first optical beam path and second optical beam path are aligned within a misalignment tolerance of two standard deviations, allowing the peak of the Gaussian power density distribution to pass between the first optical beam path and second optical beam path, with coupling loss at the tail end of the Gaussian power density distribution.

20. The method of claim 19, further comprising generating an optical beam fitting a beam profile mask comprised of a flat top profile at an upper bound and a minimum Gaussian profile at a lower bound.
